(19) United States
(12) Patent Application Publication
(10) Pub. No.: US 2026/0347162 A1
(43) Pub. Date: Nov. 5, 2026

(54) AUTOMATED SYSTEM AND METHOD FOR PERSONALIZED COSMETIC FORMULATION, ON-DEMAND PRODUCTION, AND PACKAGING USING ADAPTIVE MACHINE LEARNING AND FORMULA CODE VERIFICATION

(71) Applicant: Chanatda Williams, Irvine, CA (US)

(72) Inventor: Chanatda Williams, Irvine, CA (US)

(21) Appl. No.: 19/708,908

(22) Filed: Jun. 16, 2026

(51) Int. Cl. B67C 3/22; B65C 3/06; G06K 7/14

(52) U.S. Cl. CPC B67C 3/22; B65C 3/06; G06K 7/1413; G06K 7/1417

(57) ABSTRACT

An automated system for on-demand personalized cosmetic production at an operator deployment site. A questionnaire collects self-reported skin observations without hardware sensors or photographs and aggregates responses into a multi-dimensional skin profile vector with isolated domain dimensions. A three-layer machine learning engine comprising individual, cohort, and ingredient-level models processes the vector through a non-bypassable safety validation layer to produce a formula specification. The specification is encoded as a self-contained Formula Code containing the complete formula, which the apparatus accepts as sole input and reconstructs by decoding rather than retrieving from a database. The apparatus then executes a production cycle: dispensing active concentrates and base carrier directly into a product vessel without an intermediate mixing chamber, capping the vessel wherein cap confirmation triggers mixing, applying mechanical energy to the sealed vessel without direct product contact, and generating a regulatory-compliant labeled product vessel and printed outer carton in parallel.

### CROSS-REFERENCE TO RELATED APPLICATIONS

Not Applicable.

### TECHNICAL FIELD

The present invention relates to automated personalized cosmetic production systems and methods. More specifically, the invention relates to a system and method for producing individualized topical cosmetic formulations on demand at a point-of-production location, whether a retail store, shopping mall kiosk, salon, clinic, or any other operator deployment site, using a multi-layer machine learning engine to generate a personalized formula specification, a self-contained encrypted Formula Code that encodes the complete formula specification and is decoded locally by the production apparatus without any network connection, and an integrated automated apparatus that dispenses, seals, mixes, labels, and packages the personalized product without an intermediate mixing chamber.

### BACKGROUND OF THE INVENTION

Topical cosmetic products, including serums, moisturizers, and cleansers, are predominantly formulated for generalized skin profiles. Despite extensive product variety in commercial markets, the fundamental limitation of mass-produced cosmetics is that each product represents a static formula optimized for an assumed average user rather than the dynamic, individual skin conditions of any particular consumer.

A structural shift in consumer behavior compounds this limitation. Conscious consumption, the deliberate choice to buy only what is needed, reduce waste, and demand products that serve the individual rather than the mass market, has fundamentally and permanently reshaped consumer expectations across categories. In the skincare industry, this shift is visible in the rejection of unnecessary inventory, the demand for transparency in ingredients, and the expectation that a product is made for a specific person rather than manufactured speculatively for an imagined average. Yet the production side of the industry has not kept pace. Most brands continue to mass-produce formulas in large batch quantities, warehousing inventory that may never be sold, while consumers cycle through products that were never designed specifically for them. The result is simultaneous waste on both sides: overproduction by brands and underperformance for consumers. A need exists not only for personalized formulations but for a production model that responds to conscious consumption with conscious production, making only what is needed, for whom it is needed, at the moment it is needed.

Prior attempts to address cosmetic personalization include questionnaire-based product recommendation systems that select from existing pre-manufactured products, laboratory-based custom formulation services that require significant lead time, and dispensing devices that blend from a fixed, finite set of formulas manufactured in advance, where the formula content itself cannot be modified based on any individual's actual skin condition. These approaches share several deficiencies: they do not produce truly custom physical formulations from individual assessment data; they are centralized and cannot be deployed at the operator deployment site to produce a finished product in a single on-demand operation; they lack a privacy-preserving production authorization mechanism that separates formula intelligence from the production unit; and they lack the integrated production cycle necessary to deliver a complete finished product in a single automated operation.

Specifically, existing automated cosmetic dispensing apparatus known in the art share a common deficiency: they require the user or operator to select from a pre-composed set of formulas, complexes, or product SKUs presented at the device interface, and store the formula data locally on the apparatus. For example, robot-arm-based retail dispensing systems (see e.g., U.S. Pat. Nos. 7,624,769; 8,186,872; 8,608,371) require a user-facing interface for selection from pre-composed formulas or complexes and maintain those formula recipes on the device. Apparatus using barcode scanners as input devices (see e.g., U.S. Pat. Nos. 6,672,341; 8,141,596) similarly store formula specifications locally and use the barcode only to identify which locally-stored formula to execute, in contrast to a system in which the apparatus stores no pre-loaded formula database and decodes the complete formula specification from the Formula Code using a local on-board decode engine at time of production. Apparatus employing dedicated nozzles specific to individual liquid ingredients (see e.g., U.S. Pat. No 11,890,588) likewise require user selection from pre-defined formulas through an integrated software application and do not implement a cryptographically verified, single-use production authorization architecture. None of these apparatus separates formula intelligence from the physical production unit or prevents formula data from persisting on the apparatus. Furthermore, existing ML-based skincare personalization systems rely on hardware skin sensors and photograph analysis for data collection, creating deployment constraints and economical barrier. Some personalization systems use questionnaire-based input and construct genuinely individualized formulas from the ground up. Prose, Inc., for example, uses a multi-factor consultation to select from a library of active ingredients and produce a formula unique to each user, manufactured to order at a centralized facility and shipped to the end recipient. This represents a meaningful advance over static mass-market products. Systems using physical corneocyte hydration measurements, sebum oil-level sensors, and computer vision analysis of skin photographs (see e.g., U.S. Pat. Nos. 10,546,658; 11,574,739) require specialized hardware instrumentation at each deployment site. Systems using protein biomarker analysis from immunoassay devices (see e.g., U.S. Pat. Nos. 11,501,356; 11,741,523) require clinical laboratory equipment. None of these systems implements a purely observational questionnaire-based assessment that operates without any hardware dermal measurement, nor a three-layer ML architecture with an always-active rule-based safety validation layer that post-processes all model outputs without bypass. The continuation application US 2023/0335288 A1, pending as of the filing date of the present application, shares the same sensor-and-photograph input requirement as its parent applications and does not disclose the observational questionnaire, proxy variant mechanism, or three-layer ML architecture claimed herein. Additionally, systems for mixing personalized skincare compositions without direct product contact (see e.g., U.S. Pat. No. 11,440,045) rely on compressive mechanical action applied to a flexible single-use intermediate pod, which is an architecturally distinct mechanism from the whole-vessel vibration oscillation and through-wall ultrasonic transduction claimed herein, and do not disclose a rigid-wall final consumer container as the product vessel or a self-contained encrypted Formula Code architecture.

A need therefore exists for an automated system that takes a fundamentally different approach to both assessment and production. On assessment: no instrument, sensor, or camera is better positioned to report how skin feels, reacts, tightens, or changes than the person living in it. Objective measurements capture physical properties; they cannot capture the felt experience of skin sensitivity, comfort, or condition change that drives product need. The user is the primary and most accurate source of data about their own skin experience, and a skin assessment architecture built on structured self-reported observation, rather than hardware measurement, is not a compromise but a deliberate design choice grounded in that principle. On production: the system must encode the resulting personalized formula specification into a self-contained encrypted Formula Code that contains the complete specification and is reconstructed by a production apparatus that decodes the code rather than retrieving a stored formula from a database, the code being, in some embodiments, decodable locally without a network connection and execute a complete automated production cycle at any operator deployment site, and deliver a finished and labeled in a single on-demand operation, making only what is needed, for one person, at the moment of need.

### SUMMARY OF THE INVENTION

In one embodiment, the invention is an automated personalized cosmetic production apparatus configured to operate without human intervention during a normal production cycle. The apparatus accepts a single machine-readable Formula Code as its sole human-provided input, wherein the Formula Code itself contains the complete personalized formula specification in cryptographically encoded form and reconstructs the formula specification by decoding the code with an on-board decode engine rather than by retrieving a stored formula from a database. In some embodiments, the apparatus performs this decoding locally with no network connection at any point in the production sequence. The apparatus then executes a complete production cycle: dispensing active module concentrates and base carrier directly into a product vessel without an intermediate mixing chamber, automatically applying a cap wherein cap confirmation is the exclusive trigger for mixing, applying mechanical energy to the sealed vessel through the vessel exterior without direct product contact, and generating regulatory-compliant labeling and personalized outer packaging in parallel. The sole outputs delivered to the human operator are a labeled, sealed, mixed, and packaged finished cosmetic product.

In another embodiment, the invention is a machine learning formulation system in which every data point used to generate a formula specification is derived exclusively from the user's self-reported observations about their own skin, how it feels, how it has changed, how it reacts, without any hardware-based dermal measurement, photograph, or instrument-derived data. The system administers a structured observational questionnaire, aggregates responses into a multi-dimensional skin profile vector, and processes that vector through a three-layer machine learning engine: an individual longitudinal model with time-decay weighting, a population-level cohort model using density-based clustering without a pre-specified cluster count, and an ingredient-level conditional probability engine evaluating multi-component formulation affinity. All model outputs are post-processed by a rule-based safety validation layer that cannot be bypassed.

In another embodiment, the invention is a Formula Code system that serves as the sole bridge between the formulation intelligence layer and the automated production apparatus. The code is a machine-readable alphanumeric identifier that cryptographically encodes the complete formula specification, including product type, module selection, concentrations, and dispensing sequence within the code itself. The production unit decodes the specification locally with no network connection. The code implicitly encodes the product type in its structure such that no separate product-type selection is required at the apparatus. The code remains valid until the user completes a new assessment, at which point a new code is generated and becomes the current active formula. Together, the three embodiments form a single integrated system in which conscious production, making only what is needed, for one person, at the moment of need, at any operator deployment site, is the architectural outcome, whether the operator deploying the system is a clinic, a med spa, a brand, a retailer, or any other commercial entity.

### BRIEF DESCRIPTION OF THE DRAWINGS

FIG. 1 is a front-elevation schematic of the automated personalized cosmetic production apparatus showing the upper action zone and lower storage zone with major subsystems and reference numerals.

FIG. 2 is a system-level block diagram showing data flow and material flow between all five subsystems.

FIG. 3 is a detailed diagram of the dispensing nozzle array and ingredient storage subsystem showing the peristaltic pump manifold, module cartridge bay, and base reservoirs.

FIG. 4A is a detailed diagram of the vessel magazine and elevator assembly and fill station showing the direct-to-vessel dispensing architecture and vessel volume budget.

FIG. 4B is a detailed diagram of the capping station and mixing station showing the capping-as-trigger mechanism and both alternative mixing embodiments.

FIG. 5 is a detailed diagram of the vessel seal and carton print system showing the INCI consolidation engine and parallel print cycle architecture.

FIG. 6 is a complete production cycle flowchart showing all steps from Formula Code input through operator collection.

FIG. 7 is a detailed diagram of the skin assessment and machine learning formulation engine showing the adaptive questionnaire, six-dimensional skin profile vector, three-layer ML engine, and Formula Code structure.

FIG. 8 is a detailed diagram of the adverse reaction reporting system and ML feedback mechanism. The application contains eight (8) figures on nine (9) drawing sheets, with FIG. 4 presented on two sheets designated FIG. 4A and FIG. 4B.

### DETAILED DESCRIPTION OF THE PREFERRED EMBODIMENTS

### 1. System Overview

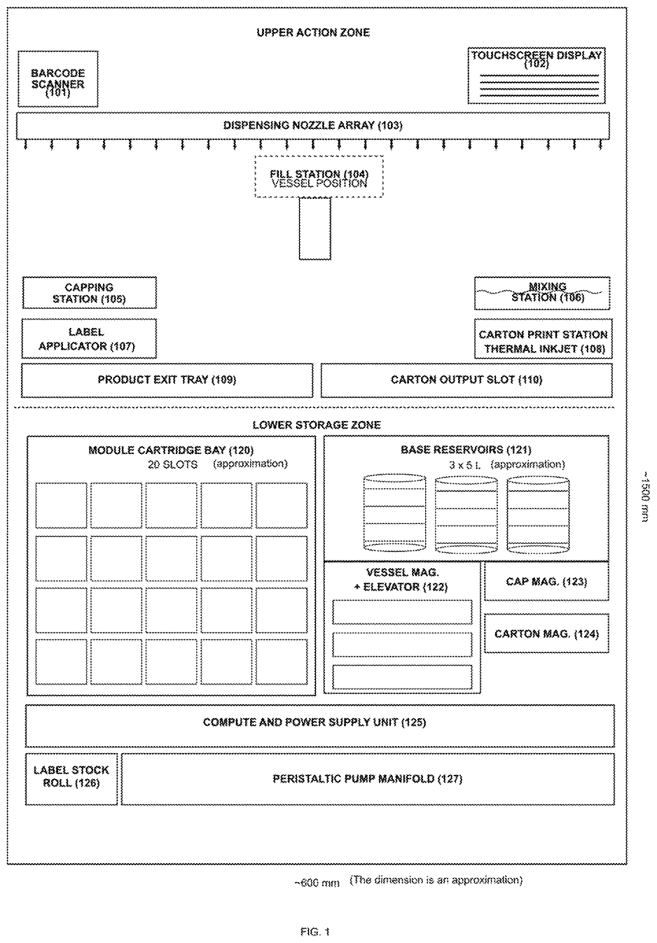

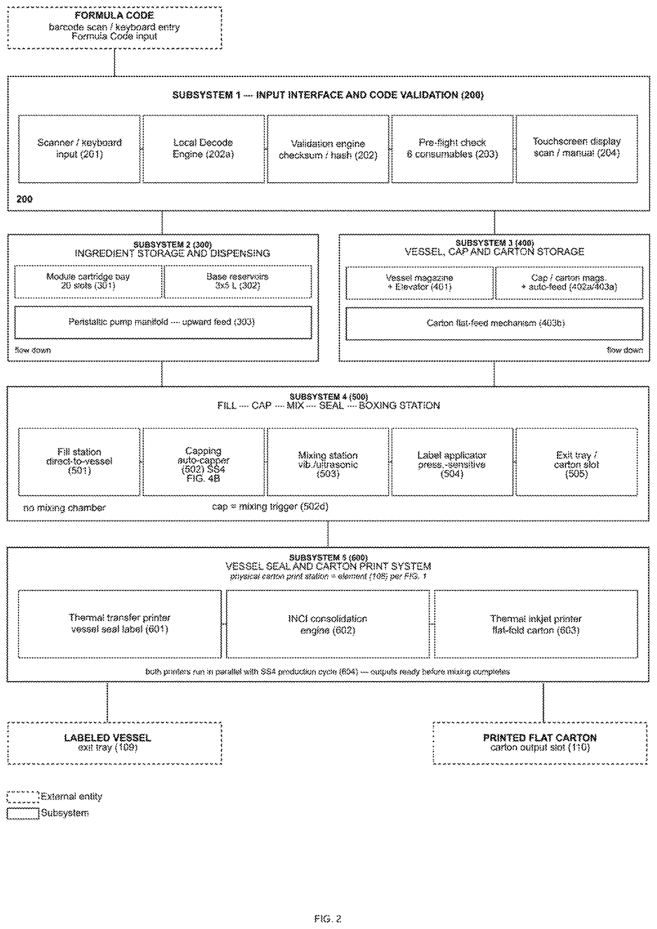

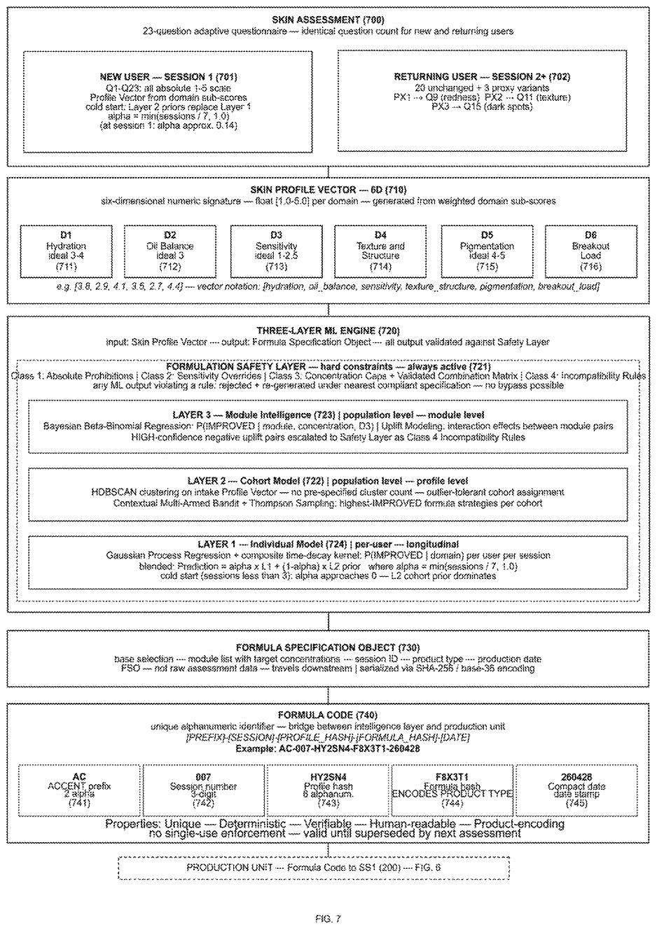

Referring to FIG. 1 and FIG. 2, the system comprises a formulation intelligence layer (FIG. 7) and an automated production apparatus (FIG. 1) communicating exclusively through a Formula Code (element 740, FIG. 7). The apparatus decodes the formula specifications; formula data is retrieved from a self-contained Formula Code at time of production using the on board decode engine. In a preferred embodiment the apparatus has an external footprint of approximately 600 millimeters in width and approximately 1500 millimeters in height; these dimensions are illustrative and do not limit the claimed invention. FIG. 1 presents the physical front-elevation layout of the apparatus using a 100-series reference numbering scheme. All remaining figures present the functional subsystem architecture using a subsystem numbering scheme. Both numbering schemes refer to the same physical components of the single integrated apparatus. The following FIG. 1 reference numerals correspond to their subsystem equivalents throughout the remaining figures and the Detailed Description: the fill station (element 104, FIG. 1) corresponds to element (501); the capping station (element 105, FIG. 1) corresponds to element (502); the mixing station (element 106, FIG. 1) corresponds to element (503); the label applicator (element 107, FIG. 1) corresponds to element (504); the carton print station (element 108, FIG. 1) corresponds to element (603); the product exit tray (element 109, FIG. 1) corresponds to the vessel-side output of element (505); the carton output slot (element 110, FIG. 1) corresponds to the carton-side output of element (505); the module cartridge bay (element 120, FIG. 1) corresponds to element (301); the base reservoirs (element 121, FIG. 1) correspond to element (302); the vessel magazine and elevator (element 122, FIG. 1) correspond to element (401); the cap magazine (element 123, FIG. 1) corresponds to element (402a); the carton magazine (element 124, FIG. 1) corresponds to element (403a); the compute and power supply unit (element 125, FIG. 1) provides the processing infrastructure for Subsystem 1 (200); the label stock roll (element 126, FIG. 1) supplies the thermal transfer printer (601); and the peristaltic pump manifold (element 127, FIG. 1) corresponds to element (303).

### 2. Subsystem 1: Input Interface and Code Validation (200)

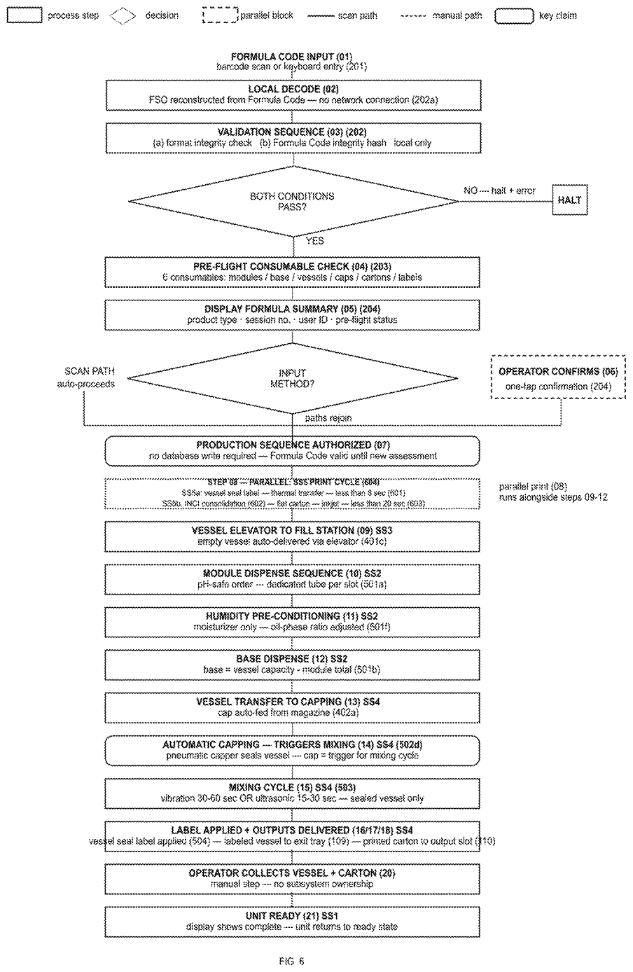

Referring to FIG. 2 and FIG. 6, Subsystem 1 (element 200) receives the Formula Code at a scanner and keyboard input interface (201) by barcode scan (element 101) or manual keyboard entry (element 102). The local decode engine (202a) decrypts the Formula Code and reconstructs the complete Formula Specification Object directly from the code using an on-board decryption key provisioned to the production unit at setup time, requiring no network connection. The validation engine (202) then performs two sequential local checks: (a) format-appropriate integrity verification, error-correction verification for QR code scan input, or Code 128 checksum verification for barcode scan input; and (b) Formula Code integrity checksum verification confirming the code has not been tampered with. Failure of either check halts production and displays a specific error condition on a touchscreen display (204). Upon passing both checks, the formula specification is available locally for the production run. No network connection is required at any step. The production unit operates as a fully autonomous, self-contained intelligent manufacturing unit and can be deployed at any operator location, a retail store, shopping mall, salon, clinic, or any other site, with no network infrastructure required at the deployment site.

The pre-flight consumable check (203) verifies six categories: active module cartridges, base carrier, vessels, caps, cartons, and labels. Checks are selective, shortfalls in categories irrelevant to the current formula do not block production. The Formula Code requires no single-use enforcement mechanism, the user's current prescription is always the most recently generated code, which naturally supersedes any prior code.

### 3. Subsystem 2: Ingredient Storage and Dispensing (300)

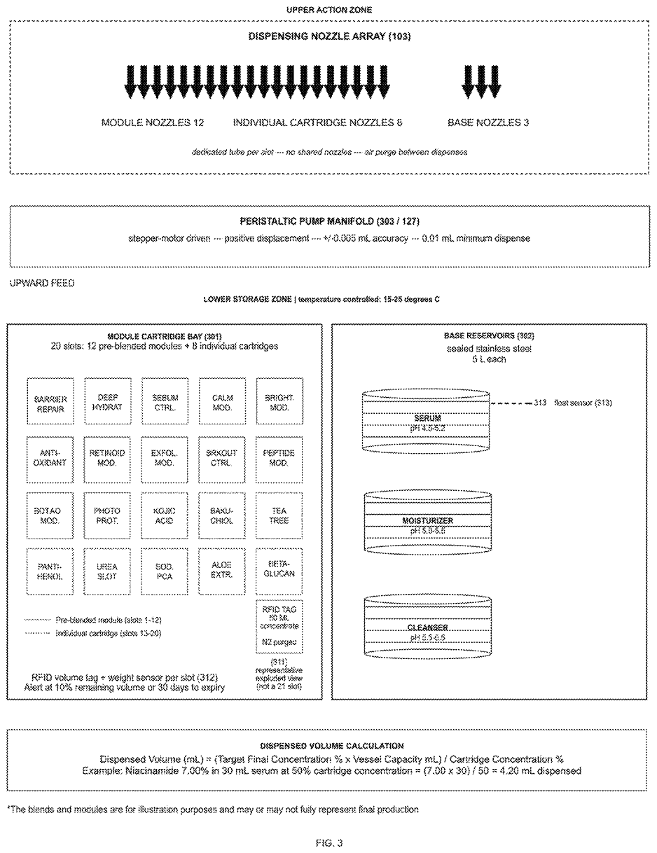

Referring to FIG. 3, Subsystem 2 (element 300) comprises a module cartridge bay (301) accommodating between twelve and twenty-four active module cartridge slots, with the illustrated preferred embodiment comprising twenty slots organized as twelve pre-blended functional module slots and eight individual active ingredient cartridge slots, each individual cartridge (311) being a nitrogen-purged concentrate container as shown in FIG. 3, base reservoirs (302) each having a capacity of five liters in a preferred embodiment and storing three distinct base carrier formulations, and a positive-displacement peristaltic pump manifold (303) providing per-dispense accuracy of plus or minus 0.005 milliliters or better per dispense, which exceeds the minimum accuracy threshold recited in the claims. The cumulative fill accuracy across all dispenses for a single production run is plus or minus 0.5 milliliters of the target total vessel volume. These are distinct measurements: per-dispense pump accuracy governs individual ingredient precision, while cumulative fill accuracy reflects the total volume tolerance of the finished product. Each slot has a dedicated fluid path to a dedicated dispensing nozzle; no fluid paths are shared. Each slot is monitored by an RFID volume tag and weight sensor per slot (element 312) constituting a consumable monitoring system that generates a low-stock alert when remaining volume falls below a defined threshold, in a preferred embodiment at ten percent remaining capacity or a defined threshold to cartridge expiry. Each base reservoir (302) includes a float sensor (313) that monitors the base carrier liquid level and generates a low-stock alert when the base carrier volume falls below the minimum required for a production run. The manifold feeds upward from the lower storage zone to the nozzle array (element 103) in the upper action zone.

### 4. Subsystem 3: Vessel, Cap, and Carton Storage (400)

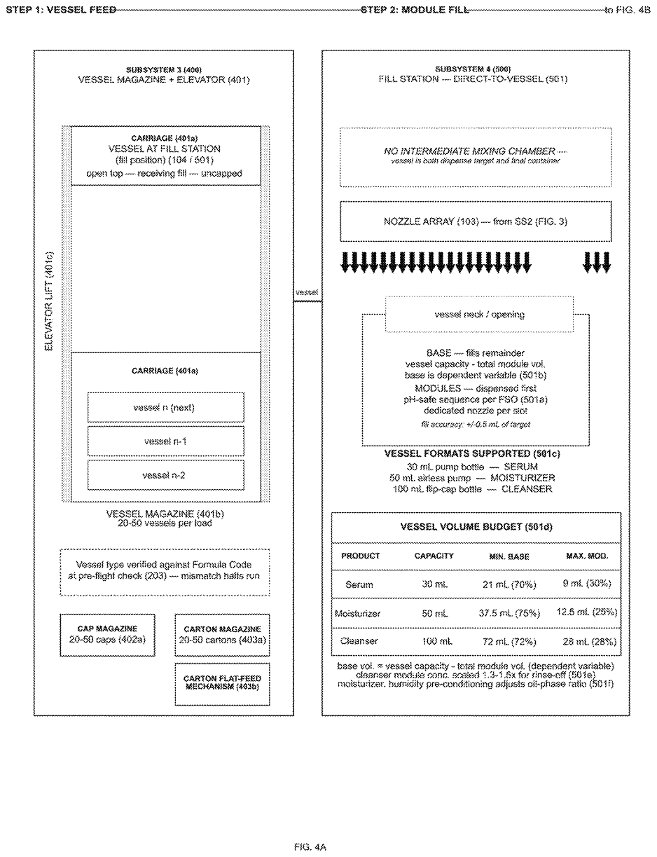

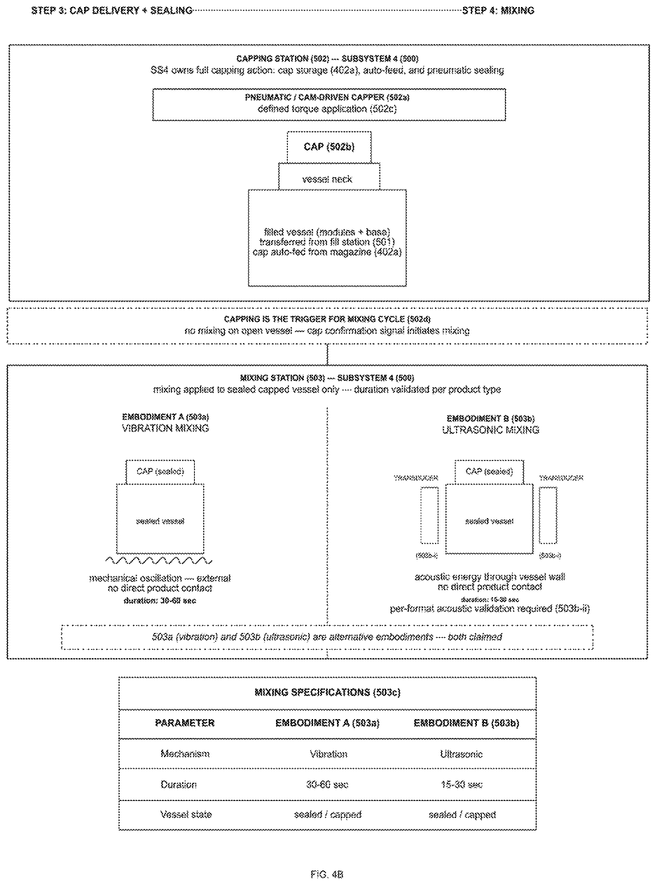

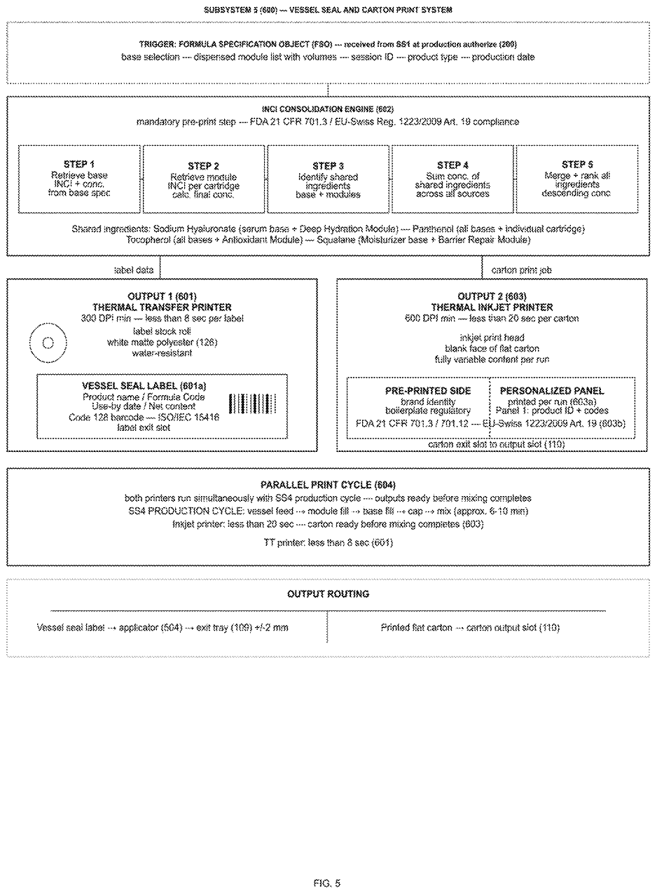

Referring to FIG. 4A, Subsystem 3 (element 400) comprises a vessel magazine (401b) storing between twenty and fifty vessels per load, advanced individually by a carriage (401a) to the fill station by an elevator lift mechanism (401c). Vessel type is verified against the product type decoded from the Formula Code at pre-flight. A carton flat-feed mechanism (403b) advances individual pre-manufactured flat-fold cartons from the carton magazine (403a) to the carton print station (element 108, FIG. 1; element 603, FIG. 5) for on-demand printing during the parallel print cycle. The cap magazine (402a) stores between twenty and fifty caps and is configured for auto-feed to the capping station. In a preferred embodiment three vessel formats are supported (501c): a thirty-milliliter pump bottle, a fifty-milliliter airless pump bottle, and a one-hundred-milliliter flip-cap bottle.

### 5. Subsystem 4: Fill-Cap-Mix-Seal-Boxing Station (500)

Referring to FIG. 4A and FIG. 4B, the fill station (501) implements direct-to-vessel dispensing: active module concentrates and base carrier are dispensed directly into the product vessel without an intermediate mixing chamber. The vessel simultaneously serves as dispense target and final consumer container. Active modules are dispensed first in a pH-safe sequence (501a); the base fills the remainder as a dependent variable (501b) in accordance with a per-format vessel volume budget (501d). For the emulsion base, oil-phase composition is humidity-adjusted at time of production (501f). For the surfactant base, module concentrations are scaled 1.3 to 1.5 times (501e) to compensate for reduced skin contact time in the rinse-off format, subject to mandatory Safety Layer concentration ceiling re-check after scaling.

Upon completion of fill, the capping station (502) comprises a pneumatic or cam-driven capper (502a) that auto-feeds a cap (502b) from the cap magazine and applies it at a defined torque (502c). The cap confirmation signal (502d) is the output of the capping station that confirms successful cap application and serves as the exclusive trigger for the mixing cycle. Following the mixing cycle, the vessel seal label is applied to the product vessel by a label applicator (element 107, FIG. 1; element 504, FIG. 2), which is a pressure-sensitive label application mechanism that receives label stock from the thermal transfer printer (601) and applies the printed label to the vessel exterior. The label applicator operates automatically as part of the Subsystem 4 production sequence with no operator intervention. Mixing is never applied to open vessels. The mixing station (503) applies mechanical energy to the sealed vessel without direct product contact in one of two alternative embodiments: Embodiment A (503a) applies mechanical oscillation via a vibration platform; Embodiment B (503b) applies acoustic energy through the vessel wall via flanking ultrasonic transducers (503b-i), subject to per-format acoustic validation (503b-ii), each embodiment operating in accordance with mixing specifications (503c) defining a validated mixing duration per product type. In both embodiments the product vessel is a rigid-wall consumer container, and the mixing mechanism has no direct product contact.

### 6. Subsystem 5: Vessel Seal and Carton Print System (600)

Referring to FIG. 5, Subsystem 5 (element 600) runs a parallel print cycle (604) concurrent with the production cycle. A mandatory INCI consolidation process (602) retrieves and merges ingredient lists from the base carrier and all dispensed modules, identifies shared ingredients, sums their concentrations, and ranks the complete list in descending order before any printing occurs. A thermal transfer printer (601) prints the vessel seal label (601a) on a water-resistant label substrate, wherein water-resistant refers to a label substrate formulated to resist moisture, humidity, and surface condensation without label separation or print degradation, in less than eight seconds. The use-by date printed on the vessel seal label is calculated automatically as the production date plus a product-type-specific stability period encoded in the Formula Specification Object. The stability period for each product type is determined by the formulation operator based on stability testing data for that product format; in a preferred embodiment the stability period is between six and twenty-four months from the production date, and this calculation requires no operator input. A thermal inkjet printer (603) prints the personalized panel (603a), including the regulatory ingredient declaration (603b) required under applicable cosmetic labeling regulations, on the flat-fold outer carton in less than twenty seconds. Both outputs are ready before the mixing cycle completes.

### 7. Formula Code (740)

Referring to FIG. 7 (element 740), the Formula Code is a unique self-contained encrypted alphanumeric identifier that encodes the complete Formula Specification Object within the code itself. The production unit decodes the FSO locally from the code with no network connection required. The code comprises five human-readable identifier segments in the following structure: [PREFIX]-[SESSION]-[PROFILE_HASH]-[FORMULA_HASH]-[DATE]. An illustrative example is AC-007-HY2SN4-F8X3T1-260428. Segment 1 (741) is the two-character ACCENT system prefix. Segment 2 (742) is a three-digit zero-padded session sequence identifier. Segment 3 (743) is a six-character alphanumeric profile hash derived from the skin profile vector. Segment 4 (744) is a six-character alphanumeric formula hash derived from the Formula Specification Object, which implicitly encodes the product type such that no separate product-type selection is required at the apparatus. Segment 5 (745) is a six-digit compact date stamp encoding the generation date for labeling purposes. These five human-readable segments are identifier components embedded within the encoded payload of the Formula Code. The complete Formula Specification Object—comprising base carrier selection, active module identifiers, target concentrations, dispensing sequence, session identifier, and product type—is encoded as a cryptographically protected payload within the code string, from which the on-board decode engine reconstructs the full FSO deterministically using a decryption key stored on the production unit. The human-readable segment identifiers serve as a verification layer and labeling reference; the encoded payload carries the complete formula data. In a preferred embodiment the payload is encoded using symmetric encryption with a key provisioned to the production unit at setup time, but the invention is not limited to any specific encryption algorithm or key management architecture. The code is encoded as a Code 128 linear barcode as the primary scan input. In an alternative embodiment the code may additionally be encoded as a QR code. Human-readable alphanumeric text is printed below the barcode to permit manual keyboard entry as a fallback input method. All input paths decode identically. For the purposes of this specification, the terms cryptographically encoded and encrypted encompass any mechanism providing data integrity and confidentiality, including symmetric encryption, asymmetric encryption, cryptographic hashing with signed encoding, tokenization, or any combination thereof. The Formula Code is valid from the moment of generation until the user completes a new assessment, at which point a new Formula Code is generated and becomes the current active formula. There is no expiry date and no single-use enforcement mechanism. The user's current prescription is always the most recently generated code.

### 8. Machine Learning Formulation Engine (720)

Referring to FIG. 7, the ML engine (720) receives a six-dimensional skin profile vector (710) and generates a Formula Specification Object (730) after Safety Layer validation. The questionnaire (700) administers 23 questions to both new users (701) and returning users (702). A critical architectural property of the questionnaire is that it operates exclusively on human self-reported skin observations and explicitly excludes all external environmental, geographic, and location-derived data inputs. The system does not receive, process, or incorporate zip-code data, weather data, climate data, UV index, humidity, altitude, water hardness, or any other location-derived environmental signal at any point in the assessment or formulation process. This exclusion is deliberate: the formulation specification is determined entirely by how the user perceives and reports their own skin condition, not by where they are located or what environmental conditions prevail at their location. This approach reflects the foundational design principle that the user is the primary and most accurate source of data about their own felt skin experience, and that self-reported perceptual data is both necessary and sufficient to generate a practically effective personalized formula specification. For returning users (702), three questions are replaced by observable proxy variants (PX1—redness change, PX2—texture change, PX3—dark spot change) generating adjustment signals of plus or minus 0.50, plus or minus 0.25, or zero applied to the corresponding prior-session domain scores. The questionnaire collects only observational responses; no hardware dermal measurements or photographs are used.

The profile vector (710) comprises six domain scores (D1-D6)—hydration (711), oil balance (712), sensitivity (713), texture and structure (714), pigmentation (715), and breakout load (716) on a normalized 1.0-5.0 scale. For domain D3 (Sensitivity), a score of 1.0 indicates minimal skin sensitivity or reactivity, and a score of 5.0 indicates maximum sensitivity or reactivity; the Safety Layer Class 2 rule triggers when the D3 score exceeds a defined threshold because a higher D3 score represents elevated sensitivity that restricts formulation options. The ideal target range for D3 is 1.0 to 2.5 for users with normal reactivity. For domain D6 (Breakout Load), a score of 1.0 indicates clear skin with no active breakout activity, and a score of 5.0 indicates maximum breakout load; an ideal target range for D6 is 1.0 to 2.0. The three-layer ML engine processes this vector through Layer 1 (724) (individual-level longitudinal probabilistic regression modeling conditional probability of improvement per domain per user, implemented with a time-decay kernel and session-count-dependent blending coefficient), Layer 2 (722) (population-level density-based cohort clustering without pre-specified cluster count), and Layer 3 (723) (ingredient and module-level probabilistic compatibility model updated from observed formulation outcomes), consistent with the layer numbering in the claims. In one embodiment, Layer 1 implements Gaussian Process Regression with a composite time-decay kernel, wherein the prediction for each domain is a blended value: Prediction=alpha times L1 plus (1 minus alpha) times L2 prior, where alpha equals the minimum of sessions divided by seven and 1.0, providing a cold-start mechanism for new users. In one embodiment, Layer 2 implements HDBSCAN density-based clustering on intake profile vectors with a Contextual Multi-Armed Bandit using Thompson Sampling to identify highest-performing formula strategies per cohort. In one embodiment, Layer 3 implements a Beta-Binomial update model tracking ingredient performance outcomes per module and concentration level, with high-confidence negative uplift pairs escalated to the Safety Layer as Class 4 Incompatibility Rules. The Formula Specification Object is serialized using SHA-256 hashing with base-36 encoding prior to Formula Code generation. These specific algorithmic implementations are exemplary embodiments and the claims are not limited to any specific algorithm or implementation. All outputs pass through the Formulation Safety Layer (721) which cannot be bypassed; violating outputs are rejected and re-generated. The Safety Layer implements a hierarchical rule taxonomy organized by override priority comprising four rule classes. Class 1, Absolute Prohibition Rules, permanently exclude specified ingredient combinations for a specific user regardless of any model layer output; these rules are set following a Grade 3 adverse reaction event and cannot be overridden by any subsequent model prediction. Class 2, Sensitivity Override Rules, restrict the formulation to low-irritation-profile modules and prevent potency escalation when the D3 sensitivity domain score exceeds a defined threshold, reflecting elevated user sensitivity or reactivity. Class 3, Concentration Cap Rules, define maximum allowable concentrations for each active ingredient category; any model output specifying a concentration exceeding the cap for that category is rejected and regenerated at the nearest compliant concentration. Class 4, Incompatibility Rules, encode ingredient pairs identified by the third model layer as having high-confidence negative interaction findings; once escalated from the model layer to the Safety Layer, these pairs are permanently excluded from co-formulation without requiring model retraining.

### 9. Adverse Reaction Feedback (800)

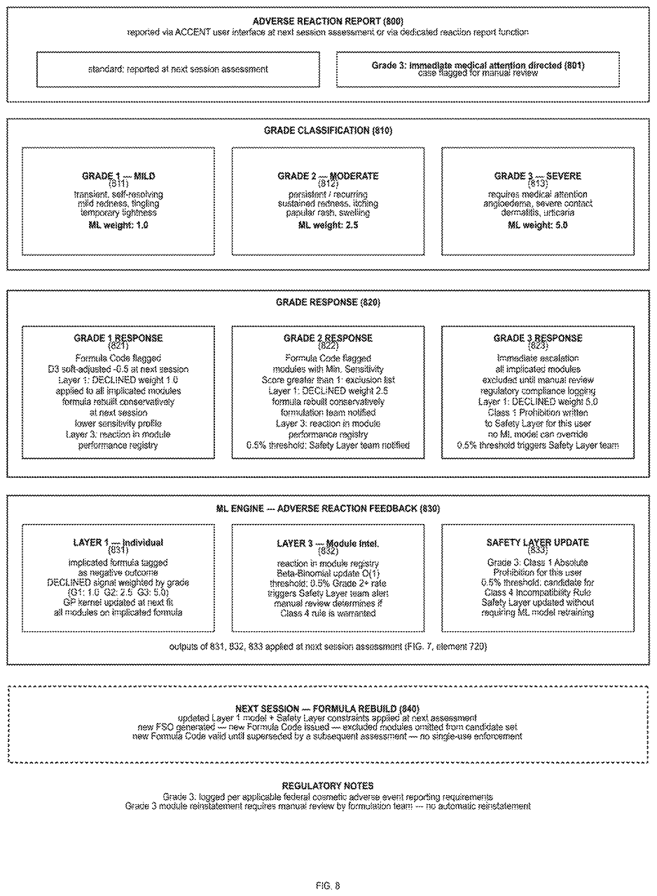

Referring to FIG. 8, an adverse reaction report (800) directs immediate medical attention for severe events (801) and is otherwise reported at the next session. Reactions are graded under a grade classification (810) as Grade 1 mild (811), Grade 2 moderate (812), or Grade 3 severe (813), with ML weights of 1.0, 2.5, and 5.0 respectively. A corresponding graded response (820) is applied: a Grade 1 response (821) soft-adjusts the sensitivity domain and records a low-weight declined signal; a Grade 2 response (822) places implicated modules on an exclusion list and notifies the formulation team; and a Grade 3 response (823) triggers immediate escalation, a Class 1 Absolute Prohibition for that user, and regulatory compliance logging in accordance with federal cosmetic adverse event reporting requirements. The adverse reaction feedback process (830) updates Layer 1 individual predictions (831), Layer 3 module performance estimates (832), and the Safety Layer rules (833). At the next session, a formula rebuild (840) issues a new Formula Code with implicated modules excluded.

What is claimed is:

1. An automated personalized cosmetic production apparatus comprising: a code validation subsystem configured to receive a machine-readable Formula Code, validate the code by verifying an integrity check appropriate to the scan format comprising error-correction verification for QR code input or checksum verification for Code 128 barcode input, and verifying a Formula Code integrity checksum confirming the code has not been tampered with, and reconstruct a complete personalized formula specification object from the code using an on-board decode engine, wherein the machine-readable Formula Code itself contains the complete formula specification object in cryptographically encoded form such that the formula specification object is reconstructed by decoding the code rather than by using the code to retrieve a stored formula specification from a database, the apparatus accepts no user-facing selection of ingredients or formulas at the device interface, and the product type is decoded implicitly from the Formula Code without requiring any separate product-type selection input at the apparatus; an ingredient dispensing subsystem comprising a plurality of active module cartridge slots each having a dedicated fluid path to a dedicated dispensing nozzle, and one or more base carrier reservoirs each having a dedicated fluid path to a dedicated dispensing nozzle, wherein no fluid path is shared between slots; a fill station configured to dispense active module concentrates and a base carrier fluid directly into a product vessel without an intermediate mixing chamber, wherein the product vessel serves simultaneously as the dispense target and the final consumer container; a capping station configured to automatically apply a cap to the filled product vessel, wherein confirmation of cap application generates a trigger signal; and a mixing station configured to receive the trigger signal and apply mechanical energy to the sealed product vessel through the vessel exterior without direct product contact.

2. The apparatus of claim 1, wherein the mixing station comprises either a first mixing embodiment that applies mechanical oscillation to the sealed vessel via a vibration platform or a second mixing embodiment that applies acoustic energy to the sealed vessel via one or more ultrasonic transducers positioned adjacent to the vessel exterior, wherein the product vessel is a rigid-wall consumer container serving as the final consumer product container in both embodiments.

3. The apparatus of claim 1, further comprising a parallel print system configured to execute a vessel seal label printing operation and a personalized outer packaging printing operation concurrently with the filling, capping, and mixing operations, such that both print outputs are ready before the mixing operation completes.

4. The apparatus of claim 1, wherein the parallel print system comprises: a first printer configured to print a vessel seal label on a water-resistant label substrate, the label comprising a product name, a formula code, a machine-readable barcode, and a use-by date; and a second printer configured to print a personalized panel on a pre-manufactured flat-fold outer carton, the personalized panel comprising a regulatory-compliant ingredient declaration generated by an INCI consolidation engine that retrieves ingredient identities and concentrations from the selected base carrier and each dispensed active module, sums concentrations of shared ingredients across all sources, and ranks all ingredients in descending order of final concentration.

5. The apparatus of claim 1, wherein the code validation subsystem is further configured to perform a pre-flight consumable check verifying available quantities of active module cartridges, base carrier, product vessels, caps, outer packaging, and label stock before initiating the production cycle, halting production and displaying an error condition without producing a partial product for shortfalls in categories relevant to the current production run, and wherein the Formula Code remains valid from the time of generation until the user generates a new Formula Code by completing a new assessment.

6. The apparatus of claim 1, further comprising a positive-displacement pump manifold providing per-dispense accuracy of plus or minus 0.01 milliliters or better for each active module cartridge slot, and a vessel delivery mechanism configured to advance individual empty product vessels from a storage magazine to the fill station automatically, wherein the ingredient dispensing subsystem dispenses active module concentrates in a pH-safe sequence determined by the formula specification object, and wherein the base carrier volume dispensed is a dependent variable equal to vessel capacity minus total active module volume such that the base carrier fills the vessel remainder.

7. A method of producing a personalized cosmetic product, the method comprising: obtaining a formula specification object by decoding a machine-readable Formula Code, wherein the Formula Code itself contains the complete formula specification object in cryptographically encoded form such that the formula specification object is recovered by decoding the code rather than by using the code to retrieve a stored formula specification from a database; dispensing one or more active ingredient module concentrates and a base carrier fluid directly into a product vessel without an intermediate mixing chamber, the product vessel serving simultaneously as the dispense target and the final consumer container; automatically applying a cap to the filled product vessel, wherein confirmation of cap application generates a trigger signal; and in response to the trigger signal, applying mechanical energy to the sealed product vessel through the vessel exterior without direct product contact, thereby producing a mixed personalized cosmetic product within the sealed final consumer container.

8. The method of claim 7, further comprising, prior to obtaining the formula specification object: administering a structured skin assessment questionnaire to a user, wherein every data point used to generate the formula specification object is derived exclusively from the user's self-reported observations of their own skin; generating a multi-dimensional skin profile vector from the responses, wherein each domain dimension is determined by a non-overlapping subset of the questionnaire responses; processing the skin profile vector through a machine learning system comprising an individual-level model layer, a population-level cohort model layer, and an ingredient-level model layer; validating the combined output of the model layers against a rule-based safety validation layer that cannot be bypassed or overridden by any model layer output, the validated combined output constituting the formula specification object; and encoding the formula specification object as the machine-readable Formula Code.

9. A computer-implemented system for generating personalized cosmetic formulation specifications from human self-reported skin observations, the system comprising: a questionnaire engine configured to administer a structured skin assessment to a user, wherein every data point used to generate the formulation specification is derived exclusively from the user's self-reported responses to observational questions describing how the user perceives or feels about their own skin, and wherein the system does not collect, require, or process any hardware-based dermal measurement, photograph, image capture, spectroscopic reading, biomarker assay, or any other instrument-derived skin data at any point in the formulation process, and wherein the system explicitly excludes all external environmental, geographic, zip-code-based, weather, climate, or location-derived data from the formulation process such that the formulation specification is determined solely by the user's self-reported skin perceptions and no other input source; a profile vector generator configured to aggregate the self-reported responses into a multi-dimensional numerical skin profile vector in which specific, non-overlapping subsets of questions map exclusively to mathematically isolated domain scores, each domain score occupying an independent dimension of the vector such that each dimension is determined by its designated question subset and no other questions, the vector thereby functioning as a coordinate in a multi-dimensional skin condition space derived entirely from human self-perception; and a formulation engine configured to receive the skin profile vector and output a personalized formula specification object specifying active ingredient modules and concentrations.

10. The system of claim 9, wherein for returning users having at least one prior session, a subset of the questionnaire questions is replaced by observable proxy variants that each generate a signed adjustment signal applied to the corresponding prior-session domain score component of the skin profile vector, wherein each proxy variant is anchored to a visible skin change observable by the user without any instrument.

11. The system of claim 9, wherein the questionnaire engine administers a fixed total question count to both new users and returning users, wherein the total number of questions answered per session is constant regardless of session history, and wherein for returning users a defined subset of questions is replaced by observable proxy variants while the total question count remains unchanged.

12. A machine learning system for generating personalized cosmetic formulation specifications, the system comprising: a first model layer operating at the individual user level, configured to maintain a longitudinal probabilistic model of formulation outcomes for each user across sessions, wherein the individual model applies time-decay weighting to prior session observations such that more recent sessions have greater influence on current predictions; a second model layer operating at the population level, configured to identify cohorts of users with similar skin profile characteristics and to derive cohort-level formulation priors, wherein the number of cohorts is determined by data topology without a pre-specified cluster count; a third model layer operating at the ingredient and module level, configured to estimate efficacy and compatibility of individual active ingredient modules and combinations thereof using a probabilistic compatibility model that updates its estimates from observed formulation outcomes, wherein the probabilistic compatibility model encompasses any statistical or machine learning approach that generates conditional probability estimates of ingredient efficacy and compatibility including but not limited to Bayesian inference, neural network-based probability estimation, random forest classifiers, gradient boosting models, and regression-based compatibility scoring; and a rule-based safety validation layer configured to post-process the combined output of the first, second, and third model layers before any formula specification is generated, wherein any combined output that violates a constraint rule is rejected and regenerated under the nearest compliant specification, and wherein the safety validation layer cannot be bypassed or overridden by any model layer output.

13. The system of claim 12, wherein the first model layer blends individual-level predictions with second model layer cohort priors using a session-count-dependent coefficient, such that predictions for users with few prior sessions are dominated by cohort priors and transition progressively toward individual predictions as session history accumulates.

14. The system of claim 12, wherein the rule-based safety validation layer comprises a hierarchical rule taxonomy organized by override priority, comprising: absolute prohibition rules permanently excluding specified ingredient combinations for a specific user regardless of model output; sensitivity override rules restricting formulation when a sensitivity domain score exceeds a threshold indicating elevated user sensitivity; concentration cap rules defining maximum allowable concentrations per active category; and incompatibility rules derived from high-confidence negative interaction findings escalated from the third model layer.

15. The system of claim 12, wherein the third model layer escalates high-confidence negative interaction findings between active module pairs to the rule-based safety validation layer for encoding as permanent incompatibility constraints, such that the safety validation layer is continuously updated from model learning without requiring manual rule authoring.

16. The system of claim 12, further comprising an adverse reaction feedback mechanism configured to: receive a graded adverse reaction report; weight the feedback signal by the reaction severity grade; update the first model layer individual predictions, the third model layer module performance estimates, and the safety validation layer constraints based on the weighted signal; and generate a revised formula specification for the next session with all implicated modules excluded from the candidate set.

17. The system of claim 12, further comprising a Formula Code generator configured to encode the complete formula specification output as a self-contained machine-readable alphanumeric code comprising a profile-derived cryptographic hash segment and a formulation-derived cryptographic hash segment that implicitly encodes product type, wherein the code itself contains the complete formula specification in cryptographically encoded form such that a production apparatus reconstructs the formula specification object by decoding the code rather than by retrieving a stored formula specification from a database, and wherein the code remains valid until superseded by a new assessment.

18. The system of claim 9, further comprising an automated production apparatus configured to receive the formula specification object via a machine-readable Formula Code, decode the formula specification object from the Formula Code wherein the Formula Code itself contains the complete formula specification object in encoded form such that it is recovered by decoding the code rather than by retrieving a stored formula specification from a database, and produce a physical personalized cosmetic product by dispensing one or more active ingredient modules and a base carrier directly into a product vessel in accordance with the decoded formula specification object, whereby the formula specification object generated by the formulation engine is transformed into a tangible personalized cosmetic product.

19. The system of claim 12, further comprising an automated production apparatus configured to receive a formula specification via a machine-readable Formula Code, decode the formula specification from the Formula Code wherein the Formula Code itself contains the complete formula specification in encoded form such that it is recovered by decoding the code rather than by retrieving a stored formula specification from a database, and produce a physical personalized cosmetic product by dispensing one or more active ingredient modules and a base carrier directly into a product vessel in accordance with the decoded formula specification, whereby a formula specification generated by the first, second, and third model layers is transformed into a tangible personalized cosmetic product.

20. The system of claim 9, wherein the multi-dimensional numerical skin profile vector comprises six mathematically isolated domain dimensions each generated from a non-overlapping dedicated subset of questionnaire responses, wherein each domain dimension independently quantifies a distinct aspect of the user's self-perceived skin condition selected from the group consisting of: hydration status, sebum and oil balance, sensitivity and reactivity, texture and structural appearance, pigmentation evenness, and breakout load, and wherein no single questionnaire response contributes to more than one domain dimension score.
